(19) United States
(12) Patent Application Publication
(10) Pub. No.: US 2023/0091546 A1
(43) Pub. Date: Mar. 23, 2023

(54) HEAD POSTURE ESTIMATION DEVICE AND HEAD POSTURE ESTIMATION METHOD

(71) Applicant: Mitsubishi Electric Corporation, Tokyo (JP)

(72) Inventors: Ryosuke TORAMA, Tokyo (JP); Takafumi MARUTANI, Tokyo (JP); Keita YOSHIDA, Tokyo (JP)

(73) Assignee: Mitsubishi Electric Corporation, Tokyo (JP)

(21) Appl. No.: 17/799,130

(22) PCT Filed: Feb. 17, 2020
(86) PCT No.: PCT/JP2020/005936

§ 371 Date: Aug. 11, 2022

(51) Int. Cl. G06T 7/73; G06T 19/20

(52) U.S. Cl. CPC G06T 7/75; G06T 19/20; G06T 2207/30201; G06T 2219/2004

(57) ABSTRACT

A face feature point extraction unit to extract multiple face feature points from a face image; a model posture change unit to change the position and posture of a first three-dimensional model in such a way that the errors between the positions of the multiple face feature points and the positions of multiple model feature points on the face image become less than or equal to respective thresholds for error determination; a degree of match acquisition unit to acquire the degrees of match on the face image between the positions of the multiple model feature points on the first three-dimensional model having the changed position and posture, and the positions of the multiple face feature points; and a calibration unit to calibrate the first three-dimensional model by shifting the position of a model feature point on the basis of the corresponding one of the degrees of match are included.

### TECHNICAL FIELD

The present disclosure relates to a head posture estimation device for and a head posture estimation method of estimating the position and posture of a person's head.

### BACKGROUND ART

Conventionally, a technique of estimating the position and posture in the three-dimensional space of the head of a person who is captured in an image (referred to as an “estimation target” hereinafter) by using a prepared three-dimensional model showing a person's face (referred to as a “three-dimensional model” hereinafter) is known. When the position and posture in the three-dimensional space of the head of an estimation target are estimated, there is a problem that the difference between the three-dimensional model and the estimation target, causes an error to occur between the actual position and posture of the head and the estimated position and posture of the head. A technique of correcting the estimated position and posture of the head in order to solve the problem is known.

On the other hand, a technique of using active shape models (ASM) is typically known as a technique of calibrating the model, as disclosed in, for example, Nonpatent Literature 1.

### CITATION LIST

### Patent Literature

Nonpatent Literature 1: Cootes T. F. Taylor C. J. Cooper D. K. Graham J., “Active Shape Models-Their Training and Application”, Computer Vision and Image Understanding Volume 61, Issue 1, January 1995, Pages 38-59

### SUMMARY OF INVENTION

### Technical Problem

It is necessary to calibrate the three-dimensional model in order to solve the problem that the difference between the three-dimensional model and the estimation target causes an error to occur between the actual position and posture of the head and the estimated position and posture of the head.

Although, for example, it is possible to calibrate the three-dimensional model using the technique as disclosed in above-mentioned Nonpatent Literature 1, a problem with that case is that it is necessary to prepare a large volume of data in advance.

The present disclosure is made in order to solve the above-mentioned problem, and it is therefore an object of the present disclosure to provide a head posture estimation device that can calibrate a three-dimensional model for estimating the position and posture in the three-dimensional space of a person's head without needing a large volume of data in advance.

### Solution to Problem

A head posture estimation device according to the present disclosure includes: a face image acquisition unit to acquire a face image of an estimation target; a face feature point extraction unit to extract multiple face feature points from the face image acquired by the face image acquisition unit; a model posture change unit to make a comparison on the face image between the multiple face feature points extracted by the face feature point extraction unit and multiple model feature points on a first three-dimensional model showing a person's face which correspond to the respective multiple face feature points, and to change a position and posture of the first three-dimensional model in a virtual three-dimensional space in such a way that the errors between positions of the multiple face feature points and positions of the multiple model feature points on the face image became less than or equal to respective thresholds for error determination; a degree of match acquisition unit to acquire degrees of match on the face image between the positions of the multiple model feature points on the first three-dimensional model having the position and posture of the first three-dimensional model which have been changed by the model posture change unit, and the positions of the multiple face feature points; and a calibration unit to calibrate the first three-dimensional model by shifting a position of at. least, one model feature point out of the multiple model feature points in the first three-dimensional model or. the basis of a corresponding one of the degrees of match acquired by the degree of match acquisition unit.

### Advantageous Effects of Invention

According to the present disclosure, it is possible to calibrate the three-dimensional model for estimating the position and posture in the three-dimensional space of the head of a person without needing a large volume of data in advance.

### BRIEF DESCRIPTION OF DRAWINGS

FIG. 1 is a diagram showing an example of the configuration of a head posture estimation device according to Embodiment 1;

FIG. 2 is a diagram showing a concept of an example of a three-dimensional model which the head posture estimation device uses when estimating the posture and position of the head of an estimation target in Embodiment 1;

FIG. 3A is a diagram for explaining an example of a method in Embodiment 1 of, in a calibration unit, calibrating a first three-dimensional model by shifting the positions of one or more model feature points out of multiple model feature points in the first three-dimensional model;

FIG. 3B is another diagram for explaining the example of the method in Embodiment 1 of, in the calibration unit, calibrating the first three-dimensional model by shifting the positions of one or more model feature points our. of the multiple model feature points in the first three-dimensional model;

FIG. 3C is another diagram for explaining the example of the method in Embodiment 1 of, in the calibration unit, calibrating the first three-dimensional model by shifting the positions of one or more model feature points out of the multiple model feature points in the first three-dimensional model;

FIG. 3D is another diagram for explaining the example of the method in Embodiment 1 of, in the calibration unit, calibrating the first three-dimensional model by shifting the positions of one or more model feature points out of the multiple model feature points in the first three-dimensional model;

FIG. 4 is a flowchart for explaining the operation of the head posture estimation device according to Embodiment 1;

FIG. 5 is a diagram showing an example of the configuration of a head posture estimation device according to Embodiment 2;

FIG. 6 is a diagram showing a concept of an example of a second three-dimensional model which the head posture estimation device uses when calibrating a first three-dimensional model in Embodiment 2;

FIG. 7 is a flowchart for explaining the operation of the head posture estimation device according to Embodiment 2; and

FIGS. 8A and 8B are diagrams showing examples of the hardware configuration of each of the head posture estimation devices according to Embodiments 1 and 2.

### DESCRIPTION OF EMBODIMENTS

Hereinafter, embodiments of the present disclosure will be explained in detail with reference to the drawings.

### Embodiment 1

In below-mentioned Embodiment 1, it is assumed that, as an example, a head posture estimation device 1 according to Embodiment 1 is mounted in a vehicle, and estimates the position and posture of the head of an occupant in the vehicle. In below-mentioned Embodiment 1, an occupant having a head whose position and posture are to be estimated is also referred to as an “estimation target.”

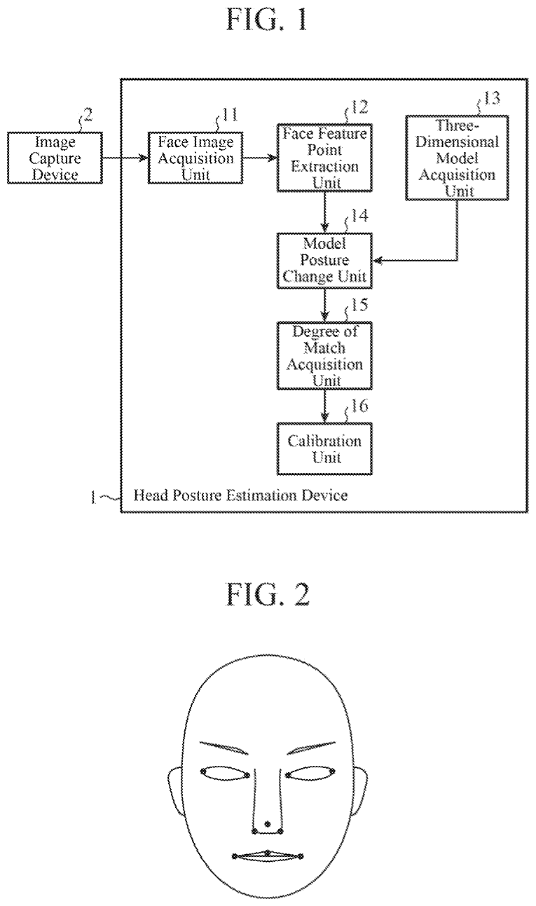

FIG. 1 is a diagram showing an example of the configuration of the head posture estimation device 1 according to Embodiment 1.

The head posture estimation device 1 is connected to an image capture device 2.

The image capture device 2 is a camera or the like which is mounted for the purpose of monitoring the inside of the vehicle, and is mounted in such a way as to be able to capture at least the face of an estimation target. The image capture device 2 outputs an image which is acquired by capturing the face of an estimation target (referred to as a “face image” hereinafter) to the head posture estimation device 1.

The image capture device 2 may be shared with, for example, a so-called “driver monitoring system (DMS).”

The head posture estimation device 1 should just be able to acquire at least a face image which is acquired by capturing the face of an estimation target.

The head posture estimation device 1 acquires a face image from the image capture device 2, and estimates the position and posture of the head of the estimation target on the basis of the acquired face image by using a three-dimensional model showing a person's face.

More concretely/ the head posture estimation device 1 places the three-dimensional model in a virtual three-dimensional space expressed in a camera coordinate system (referred to as the “virtual three-dimensional space” hereinafter) on the basis of the acquired face image, and changes the position and posture of the three-dimensional model in the virtual three-dimensional space, thereby estimating the position and posture in the actual three-dimensional space of the head of the estimation target. In the following explanation, “estimate the position and posture of the head of an estimation target” refers to “estimate the position and posture in the three-dimensional, space of the head of an estimation target.”

The three-dimensional model reflects the size of an average adult's face and the feature points of parts of the face, for example. The three-dimensional model is prepared in advance and is stored at a location which the head posture estimation device 1 can refer to. The head posture estimation device 1 may be configured in such a way as to include the three-dimensional model. In Embodiment 1, at least feature points showing six face parts are known in advance in the three-dimensional model. The face parts include the outer eye corners, the inner eye

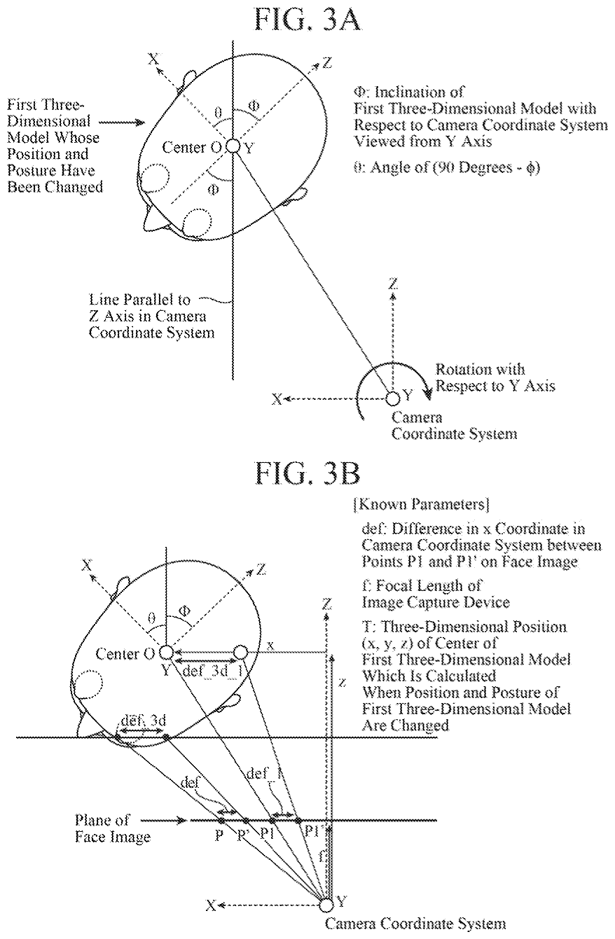

corners, the nasal tip, or the corners of the mouth. Here, FIG. 2 shows a concept of an example of the three-dimensional model which the head posture estimation device 1 uses when estimating the posture and position of the head of the estimation target in Embodiment 1. In FIG. 2, a concept of the three-dimensional model which is viewed from the front is shown.

Hereinafter, the three-dimensional model, as shown in FIG. 2, in which at least six feature points are known in advance is referred to as a “first three-dimensional model.” It is assumed in Embodiment 1 that the head posture estimation device 1 estimates the posture and position of the head of an estimation target using the first three-dimensional model shown in FIG. 2. In the first three-dimensional model shown in FIG. 2, the feature points showing the following ten parts: the outer eye corners of both eyes; the inner eye corners of both eyes; the nasal tip; both nasal wings; both corners of the mouth; and the philtrum at the upper lip are known in advance. In below-mentioned Embodiment 1, the feature points in the first three-dimensional model are also referred to as the “model feature points”.

Before estimating the position and posture of the head of the estimation target, the head posture estimation device 1 calibrates the three-dimensional model depending on the estimation target.

A method of calibrating the three-dimensional model by the head posture estimation device I will be mentioned later,

As shown in FIG. 1, the head posture estimation device 1 includes a face image acquisition unit 11, a face feature point extraction unit 12, a three-dimensional model acquisition unit 13, a model posture change unit 14, a degree of match acquisition unit 15 and a calibration unit 16.

The face image acquisition unit 11 acquires a face image of the estimation target, the face image being captured by the image capture device 2, from the image capture device 2.

The face image acquisition unit 11 outputs the acquired face image to the face feature point extraction unit 12.

The face feature point extraction unit 12 extracts feature points showing parts of the face of the estimation target from the face image acquired by the face image acquisition unit 11. In Embodiment 1, the face feature point extraction unit 12 extracts at least feature points showing six face parts from the face image. It is assumed that the feature points extracted by the face feature point extraction unit 12 correspond to feature points known in the first three-dimensional model.

In Embodiment 1 the feature points in the face image which show parts of the face of the estimation target are also referred to as the “face feature points.”

It is assumed in Embodiment 1 that the face feature points which the face feature point extraction unit 12 extracts from the face image are the ones showing the following ten parts: the outer eye corners of both eyes, the Inner eye corners of both eyes, the nasal tip, both nasal wings, both corners of the mouth, and the philtrum at the upper lip.

The face feature point extraction unit 12 should just extract the face feature points using a proper method. For example, the face feature point extraction unit 12 should just extract the face feature points using an existing feature point extraction technique based on machine learning. Instead, for example, the face feature point extraction unit 12 may extract the face feature points using an existing image recognition technique such as edge extraction. Instead, for example, the face feature point extraction unit 12 may extract the face feature points using template matching.

The face feature point extraction unit 12 outputs information about the extracted multiple face feature points to the model posture change unit 14.

The three-dimensional model acquisition unit 13 acquires the first three-dimensional model.

The three-dimensional model acquisition unit 13 places the acquired first three-dimensional model at a position set as an initial position and with a posture set as an initial posture in the virtual three-dimensional space.

The three-dimensional model acquisition unit 13 outputs information indicating that the three-dimensional model acquisition unit 13 has acquired the first three-dimensional model to the model posture change unit 14.

The model posture change unit 14 makes a comparison on the face image between the multiple face feature points extracted by the face feature point extraction unit 12 and the multiple model feature points on the first three-dimensional model which correspond to the respective multiple face feature points, and changes the position and posture of the first three-dimensional model in the virtual three-dimensional space in such a way that the errors between the positions of the multiple face feature points and the positions of the multiple model feature points on the face image become less than or equal to respective preset thresholds (referred to as “thresholds for error determination” hereinafter). It is assumed in Embodiment 1 that the case in which the errors between the positions of the multiple face feature points and the positions of the multiple model feature points on the face image are less than or equal to the respective thresholds for error determination refers to a case in which each of the errors between the positions of the multiple face feature points and the positions of the multiple model feature points on the face image is a minimum. In the face image, each of the positions of the face feature points and the model feature points is expressed by coordinates on the face image.

Concretely, the model posture change unit 14 makes a comparison on the face image between the positions of the above-mentioned ten face feature points and the positions of the above-mentioned ten model feature points. The model posture change unit 14 calculates the coordinates of each of the model feature points on the face image using, for example, a direct linear transform (DLT) method. The DLT method is an algorithm of, when the two-dimensional coordinates of a feature point on a two-dimensional image and the three-dimensional coordinates of a feature point in three dimensions which corresponds to the feature point on the two-dimensional image are known, deriving a perspective projection matrix to perform perspective projection of the three-dimensional coordinates onto the two-dimensional image.

The model posture change unit 14 performs the perspective projection of the coordinates of each of the ten model feature points on the three-dimensional model onto the face image using the DLT method.

The model posture change unit 14 rotates or translates the three-dimensional model in the virtual three-dimensional space in such a way as to cause each error between the coordinates on the face image of a model feature point which is perspective-projected onto the face image and the coordinates of the face feature point corresponding to the model feature point to have a minimum on the face image. The model posture change unit 14 rotates or translates the three-dimensional model in the virtual three-dimensional space in such a way as to cause the error between the coordinates on the face image of each of the ten model feature points and the coordinates on the face image of the corresponding face feature point to have a minimum.

The model posture change unit 14 estimates either a rotation matrix R or a translation matrix T to derive the position and posture of the three-dimensional model in the virtual three-dimensional space where each error between the coordinates on the face image of a model feature point which is perspective-projected onto the face image and the coordinates of the face feature point corresponding to the model feature point has a minimum. The model posture change unit. 14 estimates either the rotation matrix R or the translation matrix T using a least square method.

The model posture change unit. 14 changes the position and posture of the three-dimensional model placed at the initial position and with the initial posture in the virtual three-dimensional space using the rotation matrix R or the translation matrix T.

When the model posture change unit 14 changes the position and posture of the first three-dimensional model in the virtual three-dimensional space, the degree of match acquisition unit 15 acquires the degrees of match on the face image between the positions of the multiple model feature points on the first three-dimensional model having the position and posture of the first three-dimensional model which have been changed by the model posture change unit 14 and the positions of the multiple face feature points. Concretely, the degree of match acquisition unit 15 acquires the degrees of match between the positions on the face image of the ten model feature points on the three-dimensional model and the positions on the face image of the ten face feature points corresponding to the respective ten model feature points.

The degree of match acquisition unit 15 should just acquire the degrees of match on the face image between the positions of the model feature points and the positions of the face feature points from the model posture change unit 14. Because the model posture change unit 14 changes the position and coordinates of the three-dimensional model in the virtual three-dimensional space in such a way as to cause each of the errors between the positions of the model feature points and the positions of the face feature points to have a minimum, the model posture change unit 14 knows the degrees of match between the positions of the model feature points and the positions of the face feature points.

The degree of match acquisition unit 15 outputs information about the acquired degrees of match to the calibration unit 16.

The calibration unit 16 calibrates the first three-dimensional model by shifting the positions of one or more model feature points out of the multiple model feature points in the first three-dimensional model on the basis of the degrees of match acquired by the degree of match acquisition unit 15.

As mentioned above, the first three-dimensional model is prepared in advance, and reflects the size of an average adult's face and the feature points of parts of the face, for example. The first three-dimensional model does not reflect the size of the estimation target's face and the feature points of parts of the face.

Therefore, even though the model posture change unit 14 is configured in such a way as to, when changing the position and posture of the first three-dimensional model in the virtual three-dimensional space, cause each of the errors between the positions of the face feature points and the positions of the model feature points corresponding to the face feature points to have a minimum on the face image, the possibility that the positions of the face feature points and the positions of the model feature points match completely on the face image is low.

Therefore, the calibration unit 16 calibrates the first three-dimensional model depending on the estimation target, on the basis of the degrees of match on the face image between the positions of the model feature points and the positions of the face feature points, the degrees of match being acquired by the degree of match acquisition unit 15.

When the positions of the model feature points and the positions of the face feature points match on the face image, the calibration unit 16 does not need to calibrate the first three-dimensional model.

The calibration unit 16 determines the amounts of correction for the first three-dimensional model from the errors between the positions of the face feature points and the positions of the model feature points corresponding to the face feature points on the face image, the errors being observed when the model posture change unit 14 changes the position and posture of the first three-dimensional model in the virtual three-dimensional space. The errors between the positions of the face feature points and the positions of the model feature points corresponding to the face feature points on the face image, the errors being observed when the model posture change unit 14 changes the position and posture of the first three-dimensional model in the virtual three-dimensional space, are, in other words, the degrees of match on the face image between the positions of the model feature points and the positions of the face feature points, the degrees of match being acquired by the degree of match acquisition unit 15. The amount of correction for the first three-dimensional model, the amount of correction being determined by the calibration unit 16, is the amount by which a model feature point is to be shifted in the first three-dimensional model.

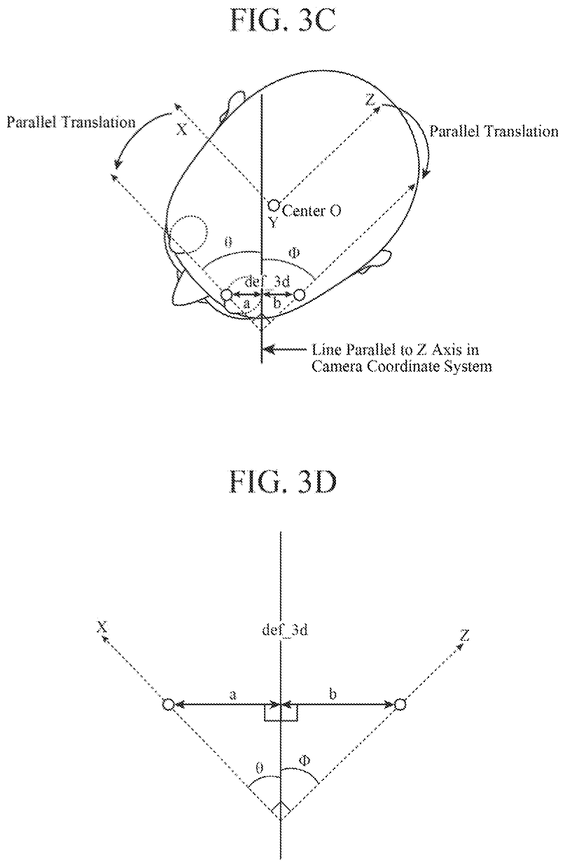

Here, FIGS. 3A to 3D are diagrams for explaining an example of the method in Embodiment 1 of, in the calibration unit 16, calibrating the first three-dimensional model by shifting the positions of one or more model feature points out of the multiple model feature points in the first three-dimensional model. In FIGS. 3A to 3D, the virtual three-dimensional apace is shown by an xz plane.

In the virtual three-dimensional space, the center of the first three-dimensional model whose position and posture have been changed by the model posture change unit 14 is denoted by O (refer to FIGS. 3A to 3C). The three-dimensional position of the center O is expressed by (x, y, z). In Embodiment 1, a coordinate system in which the center O is the point of origin, and X and Z axes are rotated with respect to an Y axis along with the posture of the first three-dimensional model is referred to as a “3D model coordinate system.” The first three-dimensional model consists of coordinate points each defined by coordinates in the first three-dimensional model. The calibration unit 16 estimates the amount of correction for the first three-dimensional model while decomposing the amount of correction into x and z components, and y and z components in the 3D model coordinate system, from the amounts of deviation in x and y coordinates in the camera coordinate system, and from the position and posture of the first three-dimensional model at that time.

First, the calibration unit 16 defines θ and ϕ, as shown in FIG. 3A.

ϕ shows the inclination of the first three-dimensional model viewed from the Y axis in the case where the center O of the first three-dimensional model is set as the point of origin in the virtual three-dimensional space expressed by the camera coordinate system. More specifically, ϕ is the angle which a line passing through the center O of the first three-dimensional model and being parallel to the Z axis in the camera coordinate system forms with the Z axis in the 3D model coordinate system.

The position and posture of the first three-dimensional model at this time are the position and posture of the first three-dimensional model in the virtual three-dimensional space which have been changed by the model posture change unit 14.

θ is an angle expressed by (90 degrees−ϕ). More specifically, θ is the angle which a line passing through the center O of the first three-dimensional model and being parallel to the Z axis in the camera coordinate system forms with the X axis in the 3D model coordinate system.

The amount of deviation def on the face image between a model feature point and a face feature point corresponding to the model feature point is expressed by def_3d in the virtual three-dimensional space, as shown in FIG. 3B. def is expressed by the difference in x coordinate in the camera coordinate system between the points P and P′ on the face image. The point P is the perspective projection of the model feature point onto the face image, and the point P′ is the face feature point corresponding to the model feature point.

Further, when the amount of deviation on the face image between the center O of the first three-dimensional model whose position and posture have been changed by the model posture change unit 14, and the feature point on the face image corresponding to the center O is denoted by def_1. def_1 is expressed by def_3d_1 in the virtual three-dimensional space. def_1 is expressed by the difference in x coordinate in the camera coordinate system between the points P1 and P1′ on the face image. The point P1 is the perspective projection of the center O onto the face image, and the point P1′ is the feature point showing the center of the head of the estimation target on the face image.

f is the focal length of the image capture device 2. The focal length of the image capture device 2 is known in advance.

The following relation: def__1:def_3d_1=f:z is obtained from the above-mentioned relations.

As shown in FIG. 30/ the calibration unit 16 decomposes def_3d into a and b on the basis of the geometric relationship as shown in FIGS. 3A and 3B. a and b are expressed as a=def__3d×θ8/(θ+ϕ) and b=def_3d×ϕ/(θ+ϕ), respectively, using θ, ϕ and def_ 3d. In other words, θ:ϕ=a:b holds.

After decomposing def_3d into a and b, as shown in FIG. 3C, the calibration unit 16 assumes that each of the components: a and b is the height of a right-angled triangle, as shown in FIG. 3D. The calibration unit 16 calculates the x component of a and the z component of b in the coordinate system showing the first three-dimensional model, namely, in the 3D model coordinate system, using a trigonometric function, as shown in the following equations (1) and (2). The x component of a in the 3D model coordinate system is the x component of def_3d in the 3D model coordinate system, and the z component of b in the 3D model coordinate system is the z component of def_3d in the 3D model coordinate system. In the equation (1), the x component of def_3d in the 3D model coordinate system is denoted by def_3d_x. Further, in the equation (2), the z component of def_3d in the 3D model coordinate system is denoted by def_3d_z.

def_3d_x=a/sin θ equation (1)

def_3d_z=b/sin ϕ equation (2)

The calibration unit 16 substitutes a=def_3d×θ/(θ+ϕ) and b=def_3d×ϕ/(θ+ϕ) into a and b, respectively, to calculate the calibrated position of the model feature point.

Similarly, the calibration unit 16 can estimate the amount of correction in the first three-dimensional model for the model feature point from the amount of deviation in the camera coordinate system of the model feature point, the amount of deviation being based on the degree of match on the face image between the face feature point on the face image and the model feature point on the first three-dimensional model, and from the position and posture of the first three-dimensional, model, by decomposing the amount of correction into y and z components in the 3D model coordinate system. The calibration unit 16 corrects the model feature point in the first three-dimensional model on the basis of the estimated correction amount expressed by both the x and z components in the 3D model coordinate system and the y and z components in the 3D model coordinate system. At this time, the calibration unit 16 may correct, for a single frame of the face image acquired by the face image acquisition unit 11, only the deviation in a freely-selected axis of the first three-dimensional model while performing decomposition into x and z components in the 3D model coordinate system and y and z components in the 3D model coordinate system, as mentioned above, or may correct, for a single frame of the face image, x, y and z components in the 3D model coordinate system of the first three-dimensional model at one time.

The above-mentioned method of calibrating the first three-dimensional model is only an example. The calibration unit 16 may estimate the amount by which a model feature point is to be shifted, using another method. On the basis of the error between the position of a face feature point and the position of the model feature point corresponding to the face feature point on the face image, the calibration unit 16 can estimate the amount by which the model feature point is to be shifted.

After the calibration unit 16 calibrates the first three-dimensional model, an estimation unit (not illustrated) estimates the position and posture of the head of the estimation target on the basis of the face image acquired by the face image acquisition unit 11 by using the first three-dimensional model calibrated by the calibration unit 16. The estimation unit should just use a known technique, thereby estimating the position and posture of the head of the estimation target from the face image by using the first three-dimensional model calibrated by the calibration unit 16.

The operation of the head posture estimation device 1 according to Embodiment 1 will be explained.

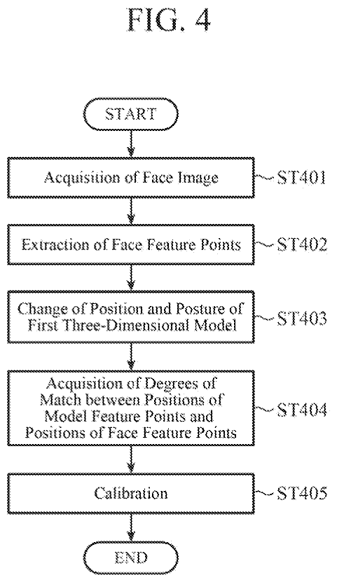

FIG. 4 is a flowchart for explaining the operation of the head posture estimation device 1 according to Embodiment 1.

The face image acquisition unit 11 acquires a face image of the estimation target which the image capture device 2 has captured from the image capture device 2 (step ST401).

The face image acquisition unit 11 outputs the acquired face image to the face feature point extraction unit 12.

The face feature point extraction unit 12 extracts face feature points showing parts of the face of the estimation target from the face image which the face image acquisition unit 11 has acquired in step ST401 (step ST402).

The face feature point extraction unit 12 outputs information about the extracted multiple face feature points to the model posture change unit 14.

The model posture change unit 14 makes a comparison on the face image between the multiple face feature points extracted by the face feature point extraction unit 12 and the multiple model feature points on the first three-dimensional model which correspond to the respective multiple face feature points, and changes the position and posture of the first three-dimensional model in the virtual three-dimensional space in such a way that the errors between the positions of the multiple face feature points and the positions of the multiple model feature points on the face image become less than or equal to the respective thresholds for error determination (step ST403).

When the model posture change unit 14, in step ST403, changes the position and posture of the first three-dimensional model in the virtual three-dimensional space, the degree of match acquisition unit 15 acquires the degrees of match on the face image between the positions of the multiple model feature points on the first three-dimensional model having the position and posture of the first three-dimensional model which have been changed by the model posture change unit 14, and the positions of the multiple face feature points (step ST404).

The degree of match acquisition unit 15 outputs information about the acquired degrees of match to the calibration unit 16.

The calibration unit 16 calibrates the first three-dimensional model by shifting the positions of one or more model feature points out of the multiple model feature points in the first three-dimensional model on the basis of the degrees of match which the degree of match acquisition unit 15 has acquired in step ST404 (step ST405).

When the calibration unit 16 calibrates the first three-dimensional model, the estimation unit estimates the position and posture of the head of the estimation target on the basis of the face image acquired by the face image acquisition unit 11 by using the first three-dimensional model calibrated by the calibration unit 16.

In this way, the head posture estimation device 1 calibrates the first three-dimensional model on the basis of the degrees of match between the positions of the face feature points and the positions of the model feature points, the degrees of match being acquired at the time of making a comparison on the face image between the positions of the face feature points in the face image and the positions of the model feature points perspective-projected onto the face image.

As mentioned above, for the purpose of calibrating the three-dimensional model using a technique of using ASM which is typically known as a technique of calibrating the model, a large volume of data must be prepared in advance. Further, for example, although calibrating the three-dimensional model on the basis of an image in which the position and posture of the head of the estimation target are known is also considered, a large number of images having patterns of various positions and postures of the head of the estimation target must be prepared in advance also in this case.

On the other hand, the head posture estimation device 1 calibrates the first three-dimensional model on the basis of the degrees of match between the positions of the face feature points and the positions of the model feature points, the degrees of match being acquired at the time of making a comparison on the face image between the positions of the face feature points in the face image and the positions of the model feature points perspective-projected onto the face image. Therefore, the head posture estimation device 1 can calibrate the three-dimensional model for estimating the position and posture in the three-dimensional space of the head of a person without needing a large volume of data in advance.

In above-mentioned Embodiment 1, the calibration unit 16 of the head posture estimation device 1 is configured in such a way as to calibrate the first three-dimensional model by shifting the positions of one or more model feature points out of the multiple model feature points in the first three-dimensional model. At this time, if the calibration unit 16 shifts the positions of multiple model feature points simultaneously, the first three-dimensional model may not be properly calibrated because of an error in the estimated amount of deviation, the error occurring in each of the model feature points. As mentioned above, the calibration unit 16 assumes that, when estimating the amount of deviation of a model feature point, the z coordinate of the model feature point whose position is to be shifted is the same as the z coordinate in the camera coordinate of the current first three-dimensional model. This assumption causes a possibility that an error occurs in the amount of deviation estimated by the calibration unit 16.

Accordingly, for example, in the head posture estimation device 1 according to Embodiment 1, the calibration unit 16 may select, or the basis of the degrees of match acquired by the degree of match acquisition unit 15, a model feature point whose position is to be shifted to calibrate the first, three-dimensional model (referred to as a “model feature point to be calibrated” hereinafter), out of the multiple model feature points.

Concretely, for example, the calibration unit 16 selects one model feature point whose degree of match between its position on the face image and the position of the face feature point is the smallest among the multiple model feature points, namely, one model feature point whose error between its position on the face image and the position of the face feature point is the largest among the multiple model feature points, as a model feature point to be calibrated, on the basis of the degrees of match acquired by the degree of match acquisition unit 15. The calibration unit 16 determines, as to the selected one model feature point to be calibrated, the amount of correction for the first three-dimensional model from the error on the two-dimensional image at the time that the model posture change unit 14 changes the position and posture of the first three-dimensional model in the virtual three-dimensional space. The calibration unit 16 then shifts the model feature point to be calibrated on the first three-dimensional model by the determined correction amount.

Instead, for example, the calibration unit 16 may select, as model feature points to be calibrated, some model feature points whose degrees of match between their positions on the face image and the positions of the face feature points are equal to or less than a preset threshold (referred to as a “threshold for selection” hereinafter) out of the multiple model feature points on the basis of the degrees of match acquired by the degree of match acquisition unit 15.

By selecting a part of the multiple model feature points as the model feature point(s) to be calibrated, and then shifting the position(s) of the model feature point(s) to be calibrated in this way, the calibration unit 16 can calibrate the first three-dimensional model. As a result, because the calibration unit 16 does not extensively calibrate the first three-dimensional model through a one-time correction as compared with the case of calibrating the first three-dimensional model by shifting the positions of all the model feature points at one time, the possibility of making an erroneous calibration of the first three-dimensional model can be reduced.

As mentioned above, according to Embodiment 1, the head posture estimation device 1 is configured in such a way as to include: the face image acquisition unit 11 to acquire a face image of an estimation target; the face feature point extraction unit 12 to extract multiple face feature points from the face image acquired by the face image acquisition unit 11; the model posture change unit 14 to make a comparison on the face image between the multiple face feature points extracted by the face feature point extraction unit 12 and multiple model feature points on a first three-dimensional model showing a person's face which correspond to the respective multiple face feature points, and to change the position and posture of the first, three-dimensional model in the virtual three-dimensional space in such a way that the errors between the positions of the multiple face feature points and the positions of the multiple model feature points on the face image became less than or equal to respective thresholds for error determination; the degree of match acquisition unit 15 to acquire the degrees of match on the face image between the positions of the multiple model feature points on the first three-dimensional model having the position and posture of the first three-dimensional model which have been changed by the model posture change unit 14, and the positions of the multiple face feature points; and the calibration unit 16 to calibrate the first three-dimensional model by shifting the position of at least one model feature point out of the multiple model feature points in the first three-dimensional model on the basis of the corresponding one of the degrees of match acquired by the degree of match acquisition unit 15. Therefore, the head posture estimation device 1 can calibrate the three-dimensional model for estimating the position and posture in the three-dimensional space of the head of a person without needing a large volume of data in advance.

Further, in the head posture estimation device 1, the calibration unit 16 can select, on the basis of the degrees of match acquired by the degree of match acquisition unit 15, a model feature point whose position is to be shifted to calibrate the first three-dimensional model, out of the multiple model feature points. Therefore, because the head posture estimation device 1 does not extensively calibrate the first three-dimensional model through a one-time correction as compared with the case oil calibrating the first three-dimensional model by shifting the positions of all the model feature points at one time, the possibility of making an erroneous calibration of the first three-dimensional model can be reduced.

### Embodiment 2

In Embodiment 1, the head posture estimation device 1 calibrates a three-dimensional model for estimating the position and posture of the head of an estimation target, on the basis of a face image by using a single three-dimensional model.

In Embodiment 2, an embodiment of calibrating a three-dimensional model for estimating the position and posture of the head of an estimation target, by using two three-dimensional models will be explained.

A head posture estimation device 1a according to Embodiment 2 is assumed to be mounted in a vehicle, like the head posture estimation device 1 according to Embodiment 1.

Further, the head posture estimation device 1a according to Embodiment 2 is connected to an image capture device 2, like the head posture estimation device 1 according to Embodiment 1.

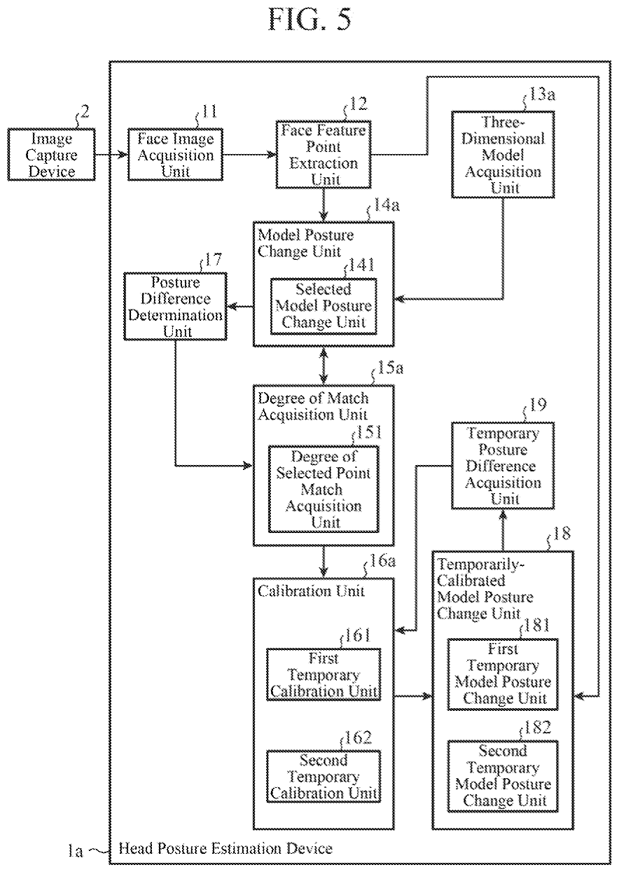

FIG. 5 is a diagram showing an example of the configuration of the head posture estimation device 1a according to Embodiment 2.

In the head posture estimation device 1a according to Embodiment 2, the same components as those of the head posture estimation device 1 explained using FIG. 1 in Embodiment 1 are denoted by the same reference signs, and a repetitive explanation will be omitted hereinafter. The configuration of the head posture estimation device 1a according to Embodiment 2 differs from that of the head posture estimation device 1 according to Embodiment 1 in that a model posture change unit 14a includes a selected model posture change unit 141. Further, the configuration of the head posture estimation device 1a differs from that of the head posture estimation device 1 according to Embodiment 1 in that a degree of match acquisition unit 15a includes a degree of selected point match acquisition unit 151. Further, the configuration of the head posture estimation device 1a differs from that of the head posture estimation device 1 according to Embodiment 1 in that a calibration unit 16a includes a first temporary calibration unit 161 and a second temporary calibration unit 162. Further, the configuration of the head posture estimation device 1a differs from that of the head posture estimation device 1 according to Embodiment 1 in that the head posture estimation device 1a includes a temporarily-calibrated model posture change unit 18 and a temporary posture difference acquisition unit 19. The temporarily-calibrated model posture change unit 18 includes a first temporary model posture change unit 181 and a second temporary model posture change unit 182. Further, the head posture estimation device 1a differs from the head posture estimation device 1 according to Embodiment 1 in the operation of a three-dimensional model acquisition unit 13a.

The head posture estimation device 1a acquires a face image from the image capture device 2 and estimates the position and posture of the head of an estimation target on the basis of the acquired face image by using a three-dimensional model showing a person's face, like the head posture estimation device 1 according to Embodiment 1.

The head posture estimation device 1a is assumed to estimate the posture and position of the head of an estimation target using a first three-dimensional model shown in FIG. 2, like the head posture estimation device 1 according to Embodiment 1.

Before estimating the position and posture of the head of the estimation target, the head posture estimation device 1a calibrates the first three-dimensional model depending on the estimation target. In Embodiment 2, the head posture estimation, device 1a calibrates the first three-dimensional model, using the first three-dimensional model and a three-dimensional model (referred to as a “second three-dimensional model” hereinafter) which has the same shape as the first three-dimensional model, but differs from the first three-dimensional model in the number of model feature points on the three-dimensional model.

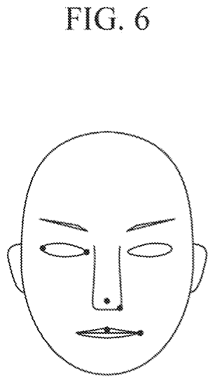

Here, FIG. 6 shows a concept of an example of the second three-dimensional model which the head posture estimation device 1a uses when calibrating the first three-dimensional model in Embodiment 2.

The shape of the second three-dimensional model is the same as that of the first three-dimensional model. The number of model feature points known in advance on the three-dimensional model differs between the second three-dimensional model and the first three-dimensional model. In the second three-dimensional model, only some model feature points out of the model feature points known on the first three-dimensional model are known. The model feature points out of the model feature points on the first three-dimensional model are determined at random, for example.

Here, as an example, it is assumed that, as shown in FIG. 6, in the second three-dimensional model, feature points showing six face parts: the outer eye corner of a right eye; the inner eye corner of a right eye; a nasal tip; a left nasal wing; the left corner of a mouth; and a philtrum at an upper lip, out of feature points showing the above-mentioned ten face parts previously known on the first three-dimensional model, are known.

In Embodiment 2, some model feature points known in the second three-dimensional model, out of the model feature points on the first three-dimensional model, are also referred to as “selected model feature points.” Here, the feature points in the second three-dimensional model which show the six face parts: the outer eye corner of the right eye; the inner eye corner of the right eye; the nasal tip; the left nasal wing; the left corner of the mouth; and the philtrum at the upper lip are the selected model feature points.

A return to the explanation of the example of the configuration of the head posture estimation device 1a is made.

The three-dimensional model acquisition unit 13a acquires the first three-dimensional model and the second three-dimensional model.

The three-dimensional model acquisition unit 13a outputs the acquired first and second three-dimensional models to the model posture change unit 14a.

The three-dimensional model acquisition unit 33a places each of the acquired first and second three-dimensional models at a position set as an initial position and with a posture set as an initial posture in a virtual three-dimensional space.

The three-dimensional model acquisition unit 13a outputs information indicating that the three-dimensional model acquisition unit has acquired the first and second three-dimensional models to the model posture change unit 14a.

The model posture change unit 14a makes a comparison on the face image between multiple face feature points extracted by a face feature point extraction unit 12 and multiple model feature points on the first three-dimensional model which correspond to the respective multiple face feature points, and changes the position and posture of the first three-dimensional model in the virtual three-dimensional space in such a way that the errors between the positions of the multiple face feature points and the positions of the multiple model feature points on the face image become less than or equal to respective thresholds for error determination. Because a concrete operation of the model, posture change unit 14a is the same as that of the model posture change unit 14 explained in Embodiment 1, a detailed explanation of the concrete operation will be omitted hereinafter.

The selected model posture change unit 141 of the model posture change unit 14a acquires some feature points (referred to as “selected face feature points” hereinafter) which correspond to the selected model feature points on the second three-dimensional model showing a person's face, out of the multiple face feature points extracted by the face feature point extraction unit 12. In Embodiment 2, the selected face feature points are feature points showing six parts: the outer eye corner of the right eye, the inner eye corner of the right eye, the nasal tip, the left nasal wing, the left corner of the mouth, and the philtrum at the upper lip, out of the face feature points showing the ten parts: the outer eye corners of both eyes, the inner eye corners of both eyes, the nasal tip, both nasal wings, both corners of the mouth, and the philtrum at the upper lip, which are extracted by the face feature point extraction unit 12 from the face image.

The selected model posture change unit 141 makes a comparison on the face image between the selected face feature points and the selected model feature points on the second three-dimensional model which correspond to the selected face feature points, and changes the position and posture of the second three-dimensional model in the virtual three-dimensional space in such a way that the errors between the positions of the selected face feature points and the positions of the selected model feature points on the face image become less than or equal to respective thresholds for error determination.

The concrete operation of the selected model posture change unit 141 differs from that of the model posture change unit 14a only in that the feature points to be compared are the selected face feature points and the selected model feature points.

A posture difference determination unit 17 determines whether or not there is a difference between the position and posture of the first three-dimensional model in the virtual three-dimensional space which have been changed by the model posture change unit 14a, and the position and posture of the second three-dimensional model in the virtual three-dimensional space which have been changed by the selected model posture change unit 141.

When determining that there is a difference between the position and posture of the first three-dimensional model and the position and posture of the second three-dimensional model, the posture difference determination unit 17 acquires the difference. The posture difference determination unit 17 causes a storage unit (not illustrated) to store information about the acquired difference.

The posture difference determination unit 17 outputs information indicating that there is a difference between the position and posture of the first three-dimensional model and the position and posture of the second three-dimensional model (referred to as “difference existence information” hereinafter) to the degree of match acquisition unit 15a.

When the difference existence information is outputted from the posture difference determination unit 17, the degree of match acquisition unit 15a acquires the degrees of match on the face image between the positions of the multiple model feature points on the first three-dimensional model having the position and posture of the first three-dimensional model which have been changed by the model posture change unit 14a, and the positions of the multiple face feature points. Because the concrete operation of the degree of match acquisition unit 15a is the same as that of the degree of match acquisition unit 15 explained in Embodiment 1, a detailed explanation will be omitted.

The degree of match acquisition unit 15a outputs information about the acquired degrees of match to the calibration unit 16a.

When the difference existence information is outputted from the posture difference determination unit 17, the degree of selected point match acquisition unit 151 of the degree of match acquisition unit 15a acquires the degrees of match (referred to as the “degrees of selected point match” hereinafter) on the face image between the positions of the selected model feature points on the second three-dimensional model having the position and posture of the second three-dimensional model which have been changed by the selected model posture change unit 141, and the positions of the selected face feature points. The concrete operation of the degree of selected point match acquisition unit 151 differs from that of the degree of match acquisition unit 15a only in that the degrees of match to be acquired are the degrees of selected point match between the positions of the selected model feature points and the positions of the selected face feature points.

The degree of selected point match acquisition unit 151 outputs information about the acquired degrees of selected point match to the calibration unit 16a.

When a difference acquired by the temporary posture difference acquisition unit 19 is smaller than a preset threshold (referred to as a “threshold for difference determination” hereinafter), the calibration unit 16a calibrates the first three-dimensional model by shifting the positions of one or more model feature points out of the multiple model feature points in the first three-dimensional model on the basis of the degrees of match acquired by the degree of match acquisition unit 15a, and also calibrates the second three-dimensional model by shifting the positions of one or more selected model feature points out of the multiple selected model feature points in the second three-dimensional model on the basis of the degrees of selected point match acquired by the degree of selected point match acquisition unit 151.

Concretely, the calibration unit 16a finalizes a temporary calibration which the first temporary calibration unit 161 has made to the first three-dimensional model, and a temporary calibration which the second temporary calibration unit 162 has made to the second three-dimensional model. The first temporary calibration unit 161 and the second temporary calibration unit 162 will be mentioned later. Further, the details of the temporary posture difference acquisition unit 19, the difference acquired by the temporary posture difference acquisition unit 19, and the threshold for difference determination will be mentioned later.

When the difference acquired by the temporary posture difference acquisition unit 19 is equal to or greater than the threshold for difference determination, the calibration unit 16a cancels the temporary calibration which the first temporary calibration unit 161 has made to the first three-dimensional model, and the temporary calibration which the second temporary calibration unit 162 has made to the second three-dimensional model, and returns the first and second three-dimensional models to their states before the temporary calibrations.

The first temporary calibration unit 161 of the calibration unit 16a makes a temporary calibration to the first three-dimensional model by shifting one or more model feature points out of the multiple model feature points in the first three-dimensional model on the basis of the degrees of match acquired by the degree of match acquisition unit 15a. The concrete operation of the first temporary calibration unit 161 is the same as that of the calibration unit 16 explained in Embodiment 1. However, the difference is that the calibration performed by the first temporary calibration unit 161 is a temporary calibration, and is not actually performed until the calibration unit 16a finalizes the temporary calibration. In Embodiment 2 explained below, the first three-dimensional model to which the first temporary calibration unit 161 has made the temporary calibration is also referred to as the “first temporarily-calibrated three-dimensional model.”

The second temporary calibration unit 162 of the calibration unit 16a makes a temporary calibration to the second three-dimensional model by shifting one or more selected model feature points on the basis of the degrees of selected point match acquired by the degree of selected point match acquisition unit 151. The concrete operation of the second temporary calibration unit 162 differs from that of the first temporary calibration unit 161 in that the target for temporary calibration is the second three-dimensional model, and the one or more model feature points to be shifted when making a temporary calibration to the second three-dimensional model are selected model feature points. The calibration performed by the second temporary calibration unit 162 is a temporary calibration, and is not actually performed until the calibration unit 16a finalizes the temporary calibration. In Embodiment 2 explained below, the second three-dimensional model to which the second temporary calibration unit 162 has made the temporary calibration is also referred to as the “second temporarily-calibrated three-dimensional model.”

The temporarily-calibrated model posture change unit 18 changes the position and posture of the first temporarily-calibrated three-dimensional model, on the basis of the face feature points extracted by the face feature point extraction unit 12 and the position and posture of the first temporarily-calibrated three-dimensional model to which the temporary calibration has been made in the virtual three-dimensional space.

Concretely, the first temporary model posture change unit 181 of the temporarily-calibrated model posture change unit 18 makes a comparison on the face image between the multiple face feature points extracted by the face feature point extraction unit 12, and the multiple model feature points on the first temporarily-calibrated three-dimensional model to which the first temporary calibration unit 161 has made the temporary calibration. The first temporary model posture change unit 181 then changes the position and posture of the first temporarily-calibrated three-dimensional model in the virtual three-dimensional space in such a way that the errors between the positions of the multiple face feature points and the positions of the multiple model feature points on the face image become less than or equal to the respective thresholds for error determination. The first temporary model posture change unit 181 first places the first temporarily-calibrated three-dimensional model to which the first temporary calibration unit 161 has made the temporary calibration at an initial position and with an initial posture in the virtual three-dimensional space. It is assumed that the initial position and posture of the first temporarily-calibrated three-dimensional model are the same as the initial position and posture of the first three-dimensional model. The first temporary model posture change unit 181 changes the position and posture of the first temporarily-calibrated three-dimensional model which is placed at the initial position and with the initial posture in the virtual three-dimensional space.

The concrete operation of the first temporary model posture change unit 181 differs from that of the model posture change unit 14a only in that the three-dimensional model whose position and posture are to be changed is the first temporarily-calibrated three-dimensional model.

Further, the temporarily-calibrated model posture change unit 18 changes the position and posture of the second temporarily-calibrated three-dimensional model, on the basis of the selected face feature points out of the face feature points extracted by the face feature point extraction unit 12 and the position and posture of the second temporarily-calibrated three-dimensional model to which the temporary calibration has been made in the virtual three-dimensional space.

Concretely, the second temporary model posture change unit 182 of the temporarily-calibrated model posture change unit 18 makes a comparison on the face image between the multiple selected face feature points out of the multiple face feature points extracted by the face feature point extraction unit 12 and the multiple selected model feature points on the second temporarily-calibrated three-dimensional model to which the second temporary calibration unit 162 has made the temporary calibration. The second temporary model posture change unit 182 then changes the position and posture of the second temporarily-calibrated three-dimensional model in the virtual three-dimensional space in such a way that the errors between the positions of the multiple selected face feature points and the positions of the multiple selected model feature points on the face image become less than or equal to the respective thresholds for error determination.

The second temporary model posture change unit 182 first places the second temporarily-calibrated three-dimensional model to which the second temporary calibration unit 162 has made the temporary calibration at an initial position and with an initial posture in the virtual three-dimensional space. It is assumed that the initial position and posture of the second temporarily-calibrated three-dimensional model are the same as the initial position and posture of the second three-dimensional model. The second temporary model posture change unit 182 changes the position and posture of the second temporarily-calibrated three-dimensional model which is placed at the initial position and with the initial posture in the virtual three-dimensional space.

The concrete operation of the second temporary model posture change unit 182 differs from that of the selected model posture change unit 141 only in that the three-dimensional model whose position and posture are to be changed is the second temporarily-calibrated three-dimensional model.

The temporary posture difference acquisition unit 19 acquires the difference between the position and posture of the first temporarily-calibrated three-dimensional model in the virtual three-dimensional space which have been changed by the first temporary model posture change unit 181, and the position and posture of the second temporarily-calibrated three-dimensional model in the virtual three-dimensional space which have been changed by the second temporary model posture change unit 132.

The temporary posture difference acquisition unit 19 outputs information about the acquired difference to the calibration unit 16a.

When the difference acquired by the temporary posture difference acquisition unit 19 is smaller than the threshold for difference determination, the calibration unit 16a calibrates the first three-dimensional model by shifting the positions of one or more model feature points out of the multiple model feature points in the first three-dimensional model on the basis of the degrees of match acquired by the degree of match acquisition unit 15a. The calibration unit 16a also calibrates the second three-dimensional model by shifting the positions of one or more selected model feature points out of the multiple selected model feature points in the second three-dimensional model on the basis of the degrees of selected point match acquired by the degree of selected point match acquisition unit 151.

Concretely, the calibration unit 16a finalizes the temporary calibration which the first temporary calibration unit 161 has made to the first three-dimensional model, and the temporary calibration which the second temporary calibration unit 162 has made to the second three-dimensional model.

In Embodiment 1, it is assumed that the threshold for difference determination is a difference value which the posture difference determination unit 17 causes the storage unit to store.

More specifically, when the difference acquired by the temporary posture difference acquisition unit 19 is smaller than the difference between the first three-dimensional model before the temporary calibration and the second three-dimensional model before the temporary calibration, the calibration unit 16a calibrates the first and second three-dimensional models.

It can be said that the fact that the difference acquired by the temporary posture difference acquisition unit 19 is smaller than the difference between the first three-dimensional model before the temporary calibration and the second three-dimensional model before the temporary calibration means that the temporary calibration made to the first three-dimensional model and the temporary calibration made to the second three-dimensional model are proper.

When the difference acquired by the temporary posture difference acquisition unit 19 is equal to or greater than the threshold for difference determination, the calibration unit 16a cancels the temporary calibration which the first temporary calibration unit 161 has made to the first three-dimensional model, and the temporary calibration which the second temporary calibration unit 162 has made to the second three-dimensional model, and returns the first and second three-dimensional models to their states before the temporary calibrations.

The operation of the head posture estimation device 1a according to Embodiment 2 will be explained.

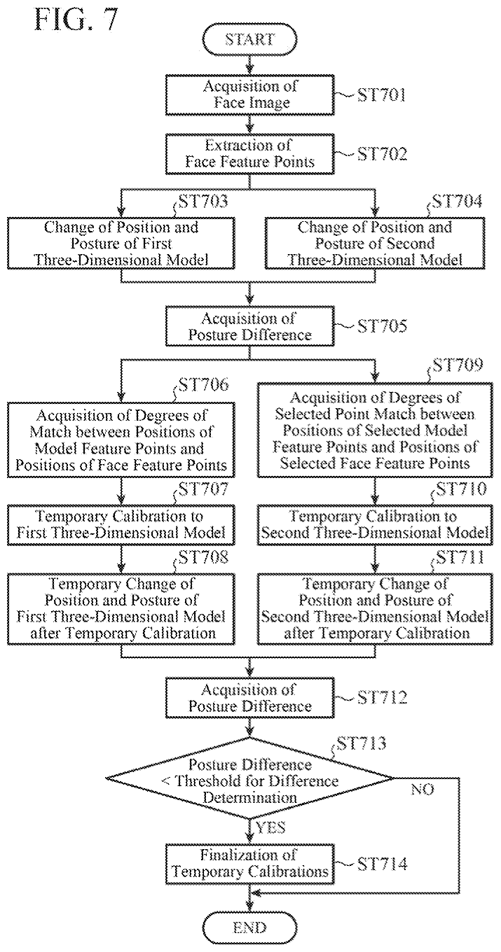

FIG. 7 is a flowchart for explaining the operation of the head posture estimation device 1a according to Embodiment 2.

A face image acquisition unit 11 acquires a face image of an estimation target, the face image being captured by the image capture device 2, from the image capture device 2 (step ST701). The concrete operation of step ST701 is the same as that of step ST401 of FIG. 4 explained in Embodiment 1.

The face image acquisition unit 11 outputs the acquired face image to the face feature point extraction unit 12.

The face feature point extraction unit 12 extracts face feature points showing parts of the face of the estimation target from the face image which the face image acquisition unit 11 has acquired in step ST701 (step ST702). The concrete operation of step ST702 is the same as that of step ST402 of FIG. 4 explained in Embodiment 1.

The face feature point extraction unit 12 outputs information about the extracted multiple face feature points to the model posture change unit 14.

The model posture change unit 14a makes a comparison on the face image between the multiple face feature points which the face feature point extraction unit 12 has extracted in step ST702, and the multiple model feature points on the first three-dimensional model which correspond to the respective multiple face feature points, and changes the position and posture of the first three-dimensional model in the virtual three-dimensional space in such a way that the errors between the positions of the multiple face feature points and the positions of the multiple model feature points on the face image become less than or equal to the respective thresholds for error determination (step ST703).

The selected model posture change unit 141 of the model posture change unit 14a makes a comparison on the face image between the selected face feature points out of the multiple face feature points which the face feature point extraction unit 12 has extracted in step ST702, and the selected model feature points on the second three-dimensional model showing a person's face which correspond to the selected face feature points, and changes the position and posture of the second three-dimensional model in the virtual three-dimensional space in such a way that the errors between the positions of the selected face feature points and the positions of the selected model feature points on the face image become less than or equal to the respective thresholds for error determination (step ST704).

The posture difference determination unit 17 determines whether there is a difference between the position and posture of the first three-dimensional model in the virtual three-dimensional space which have been changed by the model posture change unit 14a in step ST703, and the position and posture of the second three-dimensional model in the virtual three-dimensional space which have been changed by the selected model posture change unit 141 in step ST704. When determining that there is a difference between the position and posture of the first three-dimensional model and the position and posture of the second three-dimensional model, the posture difference determination unit 17 acquires the difference and causes the storage unit to store the difference (step ST705).

The posture difference determination unit 17 outputs difference existence information to the degree of match acquisition unit 15a.

When the posture difference determination unit 17 determines that there is no difference between the position and posture of the first three-dimensional model and the position and posture of the second three-dimensional model, the head posture estimation device 1a ends the operation shown in the flowchart of FIG. 7.

When the difference existence information is outputted from the posture difference determination unit 17 in step ST705, the degree of match acquisition unit 15a acquires the degrees of match on the face image between the positions of the multiple model feature points on the first three-dimensional model having the position and posture of the first three-dimensional model which have been changed by the model posture change unit 14a, and the positions of the multiple face feature points (step ST706).

The degree of match acquisition unit 15a outputs information about the acquired degrees of selected point match to the calibration unit 16a.

When the difference existence information is outputted from the posture difference determination unit 17 in step ST705, the degree of selected point match acquisition unit 151 of the degree of match acquisition unit 15a acquires the degrees of selected point match on the face image between the positions of the selected model feature points on the second three-dimensional model having the position and posture of the second three-dimensional model which have been changed by the selected model posture change unit 141, and the positions of the selected face feature points (step ST709).

The degree of selected point match acquisition unit 151 outputs information about the acquired degrees of selected point match to the calibration unit 16a.

The first temporary calibration unit 161 of the calibration unit 16a makes a temporary calibration to the first three-dimensional model by shifting one or more multiple model feature points out of the multiple model feature points in the first three-dimensional model on the basis of the degrees of match which the degree of match acquisition unit 15a has acquired in step ST706 (step ST707).

The second temporary calibration unit 162 of the calibration unit 16a makes a temporary calibration to the second three-dimensional model by shifting one or more selected model feature points out of the multiple selected model feature points in the second three-dimensional model on the basis of the degrees of selected point match which the degree of selected point match acquisition unit 151 has acquired in step ST709 (step ST710).

The first temporary model posture change unit 131 of the temporarily-calibrated model posture change unit 18 makes a comparison on the face image between the multiple face feature points which the face feature point extraction unit 12 has extracted in step ST702, and the multiple model feature points on the first temporarily-calibrated three-dimensional model to which the first temporary calibration unit 161 has made the temporary calibration in step ST707. The first temporary model posture change unit 181 then changes the position and posture of the first temporarily-calibrated three-dimensional model in the virtual three-dimensional space in such a way that the errors between the positions of the multiple face feature points and the positions of the multiple model feature points on the face image become less than or equal to the respective thresholds for error determination (step ST708).

The second temporary model posture change unit 282 of the temporarily-calibrated model posture change unit 18 makes a comparison on the face image between the multiple selected face feature points out of the multiple face feature points which the face feature point extraction unit 12 has extracted in step ST702, and the multiple selected model feature points on the second temporarily-calibrated three-dimensional model to which the second temporary calibration unit 162 has made the temporary calibration in step ST709. The second temporary model posture change unit 182 then changes the position and posture of the second temporarily-calibrated three-dimensional model in the virtual three-dimensional space in such a way that the errors between the positions of the multiple selected face feature points and the positions of the multiple selected model feature points on the face image become less than or equal to the respective thresholds for error determination (step ST711). The temporary posture difference acquisition unit 13 acquires a difference between the position and posture of the first temporarily-calibrated three-dimensional model in the virtual three-dimensional space which have been changed by the first temporary model posture change unit 181 in step ST708, and the position and posture of the second temporarily-calibrated three-dimensional model in the virtual three-dimensional space which have been changed by the second temporary model posture change unit 182 in step ST711 (step ST712).

The temporary posture difference acquisition unit 19 outputs information about the acquired difference to the calibration unit 16a.

The calibration unit 16a determines whether or not the difference which the temporary posture difference acquisition unit 19 has acquired in step ST712 is smaller than the threshold for difference determination (step ST713).

When the difference which the temporary posture difference acquisition unit 19 has acquired is smaller than the threshold for difference determination (when “YES” in step ST713), the calibration unit 16a calibrates the first three-dimensional model by shifting the positions of one or more model feature points out of the multiple model feature points in the first three-dimensional model on the basis of the degrees of match which the degree of match acquisition unit 15a has acquired in step ST706. The calibration unit 16a also calibrates the second three-dimensional model by shifting the positions of one or more selected model feature points out of the multiple selected model feature points in the second three-dimensional model on the basis of the degrees of selected point match which the degree of selected point match acquisition unit 151 has acquired in step ST709 (step ST714).

Concretely, the calibration unit 16a finalizes the temporary calibration which the first temporary calibration unit 161 has made to the first three-dimensional model in step ST707, and the temporary calibration which the second temporary calibration unit 162 has made to the second three-dimensional model in step ST710.

When the difference which the temporary posture difference acquisition unit 19 has acquired is equal to or greater than the threshold for difference determination (when “NO” in step ST713), the calibration unit 16a cancels the temporary calibration which the first temporary calibration unit 161 has made to the first three-dimensional model, and the temporary calibration which the second temporary calibration unit 162 has made to the second three-dimensional model, and returns the first and second three-dimensional models to their states before the temporary calibrations.

After the first and second three-dimensional models are calibrated, the estimation unit (not illustrated) in the head posture estimation device 1a estimates the position and posture of the head of the estimation target on the basis of the face image acquired from the image capture device 2 by using the first three-dimensional model after the calibration.

As mentioned above, the head posture estimation device 1a according to Embodiment 2 can calibrate the three-dimensional model for estimating the position and posture of the head of an estimation target by using the two three-dimensional models: the first three-dimensional model in which multiple feature points are known, and the second three-dimensional model in which some of the multiple feature points are known.

More concretely, the head posture estimation device 1a compares the difference between the first three-dimensional model before a temporary calibration and the second three-dimensional model before a temporary calibration with the difference between the first three-dimensional model after the temporary calibration and the second three-dimensional model after the temporary calibration, and, when the difference becomes small after the temporary calibrations, determines that the temporary calibrations are proper and hence finalizes the temporary calibrations. When the above-mentioned difference does not become small after the temporary calibrations, the head posture estimation device 1a does not calibrate the first and second three-dimensional models. If the head posture estimation device 1a can calibrate the first and second three-dimensional models in such a way that the positions of the face feature points completely match the positions of the model feature points, it is estimated that the position and posture of the first three-dimensional model completely match the position and posture of the second three-dimensional model.

The head posture estimation device 1a can calibrate the three-dimensional model for estimating the position and posture in the three-dimensional space of a person's head without needing a large volume of data in advance, and the head posture estimation device 1a can also make the calibration to the first three-dimensional model used when estimating the position and posture of the head of the estimation target after checking that the calibration is appropriate.

In the head posture estimation device 1a according to above-mentioned Embodiment 2, the first temporary calibration unit 161 can select a model feature point whose position is to be shifted to make a temporary calibration to the first three-dimensional model, out of the multiple model feature points, on the basis of the degrees of match acquired by the degree of match acquisition unit 15.

Further, the second temporary calibration unit 162 can select a selected model feature point whose position is to be shifted to make a temporary calibration to the second three-dimensional model, out of the selected model feature points, on the basis of the degrees of selected point match acquired by the degree of selected point match acquisition unit 151.

As a result, because the head posture estimation device 1a does not extensively calibrate the first three-dimensional model through a one-time correction as compared with the case of calibrating the first three-dimensional model by shifting the positions of all the model feature points at one time, the head posture estimation device 1a can reduce the possibility of making an erroneous calibration of the first three-dimensional model. Further, because the head posture estimation device 1a does not extensively calibrate the second three-dimensional model, through a one-time correction as compared with the case of calibrating the second three-dimensional model by shifting the positions of all the selected model feature points at one time, the head posture estimation device 1a can reduce the possibility of making an erroneous calibration of the second three-dimensional model.

As mentioned above, according to Embodiment 2, the head posture estimation device 1a includes: in addition to the components of the head posture estimation device 1 according to Embodiment 1, the selected model posture change unit 141 to make a comparison on the face image between some face feature points selected out of the multiple face feature points and the selected model feature points on the second three-dimensional model showing a person's face which correspond to the respective selected face feature points, and to change the position and posture of the second three-dimensional model in the virtual three-dimensional space in such a way that the errors between the positions of the selected face feature points and the positions of the selected model feature points on the face image become less than or equal to the respective thresholds for error determination; the degree of selected point match acquisition unit 151 to acquire the degrees of selected point match on the face image between the positions of the selected model feature points on the second three-dimensional model having the position and posture of the second three-dimensional model which have been changed by the selected model posture change unit 141, and the positions of the selected face feature points; the first temporary calibration unit 161 to make a temporary calibration to the first three-dimensional model by shifting at least one model feature point on the basis of the corresponding one of the degrees of match acquired by the degree of match acquisition unit 15a; the second temporary calibration unit 162 to make a temporary calibration to the second three-dimensional model by shifting at least one of the selected model feature points on the basis of the corresponding one of the degrees of selected point match acquired by the degree of selected point match acquisition unit 151; the first temporary model posture change unit 181 to make a comparison on the face image between multiple face feature points and multiple model feature points on the first temporarily-calibrated three-dimensional model to which the first temporary calibration unit 161 has made the temporary calibration, and to change the position and posture of the first temporarily-calibrated three-dimensional model in the virtual three-dimensional space in such a way that the errors between the positions of the multiple face feature points and the positions of the multiple model feature points on the face image become less than or equal to the respective thresholds for error determination; the second temporary model posture change unit 182 to make a comparison on the face image between the selected face feature points and the selected model feature points on the second temporarily-calibrated three-dimensional model to which the second temporary calibration unit 162 has made the temporary calibration, and to change the position and posture of the second temporarily-calibrated three-dimensional model in the virtual three-dimensional space in such a way that the errors between the positions of the selected face feature points and the positions of the selected model feature points on the face image become less than or equal to the respective thresholds for error determination; and the temporary posture difference acquisition unit 19 to acquire the difference between the position and posture of the first temporarily-calibrated three-dimensional model which have been changed by the first temporary model posture change unit 181, and the position and posture of the second temporarily-calibrated three-dimensional model which have been changed by the second temporary model posture change unit 192. When the difference acquired by the temporary posture difference acquisition unit 19 is smaller than the threshold for difference determination, the calibration unit 16a calibrates the first three-dimensional model on the basis of the corresponding one of the degrees of match acquired by the degree of match acquisition unit 15a, and also calibrates the second three-dimensional model by shifting the position of the at least one of the multiple selected model feature points in the second three-dimensional model on the basis of the corresponding one of the degrees of selected point match acquired by the degree of selected point match acquisition unit 151.

Therefore, the head posture estimation device 1a can calibrate the three-dimensional model for estimating the position and posture in the three-dimensional space of a person's head without needing a large volume of data in advance.

Further, the head posture estimation device 1a can make the calibration to the first three-dimensional model used when estimating the position and posture of the head of the estimation target after confirming that the calibration is proper. Each of the head posture estimation devices 1 and 1a according to above-mentioned Embodiments 1 and 2 may include the first three-dimensional model and the second three-dimensional model. The first and second three-dimensional models are placed at positions set as initial positions and with postures set as initial postures in the virtual three-dimensional space, for example. In this case, the head posture estimation devices 1 and 1a can be configured in such a way as not to include the three-dimensional model acquisition units 13 and 13a.

In the head posture estimation devices 1 and 1a according to above-mentioned Embodiments 1 and 2, information about the position and posture of the head of the estimation target which have been estimated by the estimation unit is outputted to, for example, a navigation device (not illustrated) mounted in the vehicle, and is used, in the navigation device, for the determination of inattentive driving.

Further, for example, the information about the position and posture of the head of the estimation target is outputted to a posture determination device (not illustrated) mounted in the vehicle, and is used, in the posture determination device, for a control operation of outputting an emergency notification of the driver's driving incapability state which is estimated when a state in which the driver's posture has become worse continues.

Further, it is assumed in above-mentioned Embodiments 1 and 2 that each of the head posture estimation devices 1 and 1a is a vehicle-mounted device mounted in the vehicle, and the head posture estimation devices 1 and 1a include the face image acquisition unit 11, the face feature point extraction unit 12, the three-dimensional model acquisition units 13 and 13a, the model posture change units 14 and 14a, the degree of match acquisition units 15 and 15a, the calibration units 16 and 16a, the posture difference determination unit 17, the temporarily-calibrated model posture change unit 18 and the temporary posture difference acquisition unit 19. No limitation thereto is intended. Some of the face image acquisition unit 11, the face feature point extraction unit 12, the three-dimensional model acquisition unit 13 or 13a, the model posture change unit 14 or 14a, the degree of match acquisition unit 15 or 15a, the calibration unit 16 or 16a, the posture difference determination unit 17, the temporarily-calibrated model posture change unit 18 and the temporary posture difference acquisition unit 19 may be mounted in the vehicle-mounted device of the vehicle and the other units may be included in a server connected to the vehicle-mounted device via a network, and as a result, a head posture estimation system may be constituted by the vehicle-mounted device and the server.

Further, each of the head posture estimation devices 1 and 1a according to above-mentioned Embodiments 1 and 2 may be applied to an application or the like of a head posture estimation system, the application being installed in a mobile information terminal, such as a smartphone, a tablet PC and a mobile phone, or the like.

Further, although in above-mentioned Embodiments 1 and 2 each of the head posture estimation devices 1 and 1a is mounted in a vehicle and estimates the position and posture of the head of an occupant in the vehicle, this is only an example. Each of the head posture estimation devices 1 and 1a according to Embodiments 1 and 2 can be applied to every device that estimates the position and posture of a person's head in a three-dimensional space on the basis of an image by using a three-dimensional model.

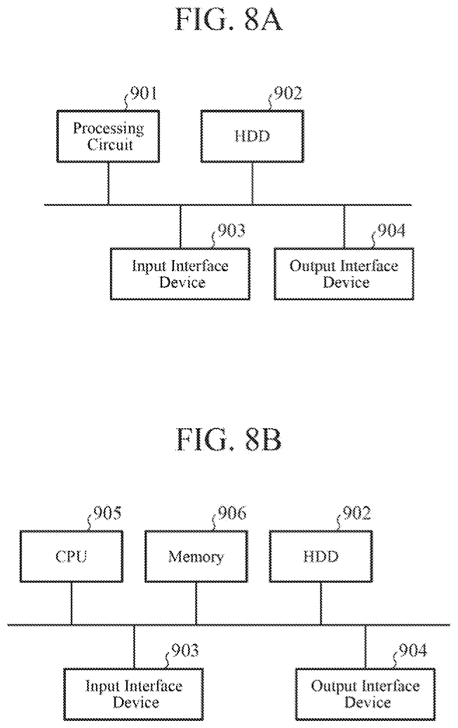

FIGS. 8A and 8B are diagrams showing examples of the hardware configuration of each of the head posture estimation devices 1 and 1aaccording to Embodiments 1 and 2.

In each of Embodiments 1 and 2, the functions of the face image acquisition unit 11, the face feature point extraction unit 12, the three-dimensional model acquisition unit 13 or 13a, the model posture change unit 14 or 14a, the degree of match acquisition unit 15 or 15a, the calibration unit 16 or 16a, the posture difference determination unit 17, the temporarily-calibrated model posture change unit 18 and the temporary posture difference acquisition unit 19 are implemented by a processing circuit 901. More specifically, each of the head posture estimation devices 1 and 1a includes the processing circuit 901 for calibrating the three-dimensional model used for the estimation of the position and posture of the head of an estimation target. The processing circuit 901 may be hardware for exclusive use as shown in FIG. 8A or a central processing unit (CPU) 905, as shown in FIG. 8B, which executes a program stored in a memory 906.

In a case where the processing circuit 901 is hardware for exclusive use, the processing circuit 901 is, for example, a single circuit, a composite circuit, a programmable processor, a parallel programmable processor, an application specific integrated circuit (ASIC), a field-programmable gate array (FPGA), or a combination thereof.

In a case where the processing circuit 901 is the CPU 905, the functions of the face image acquisition unit 11, the face feature point extraction unit 12, the three-dimensional model acquisition unit 13 or 13a, the model posture change unit 14 or 14a, the degree of match acquisition unit 15 or 15a, the calibration unit 16 or 16a, the posture difference determination unit 17, the temporarily-calibrated model posture change unit 18 and the temporary posture difference acquisition unit 19 are implemented by software, firmware, or a combination of software and firmware. More specifically, the face image acquisition unit 11, the face feature point extraction unit 12, the three-dimensional model acquisition unit 13 or 13a, the model posture change unit 14 or 14a, the degree of match acquisition unit 15 or 15a, the calibration unit 16 or 16a, the posture difference determination unit 17, the temporarily-calibrated model posture change unit 18 and the temporary posture difference acquisition unit 19 are implemented by the processing circuit like the CPU 905 that executes a program stored in a hard disk drive (HDD) 902, the memory 906 or the like, a system large-scale integration (LSI) or the like. Further, it can be said that the program stored in the HDD 902, the memory 506 or the like causes a computer to perform procedures or methods performed by the face image acquisition unit 11, the face feature point extraction unit 12, and the three-dimensional model acquisition unit 13 or 13a, the model posture change unit 14 or 14a, the degree of match acquisition unit 15 or 15a, the calibration unit 16 or 16a, the posture difference determination unit 17, the temporarily-calibrated model posture change unit 18 and the temporary posture difference acquisition unit 19. Here, the memory 906 is, for example, a non-volatile or volatile semiconductor memory, such as a RAM, a read only memory (ROM), a flash memory, an erasable programmable read only memory (EPROM) and an electrically erasable programmable read-only memory (EEPROM), a magnetic disc, a flexible disc, an optical disc, a compact disc, a mini disc, a digital versatile disc (DVD), or the like.

A part of the functions of the face image acquisition unit 21, the face feature point extraction unit 12, the three-dimensional model acquisition unit 13 or 13a, the model posture change unit 14 or 14a, the degree of match acquisition unit 15 or 15a, the calibration unit 16 or 16a, the posture difference determination unit 17, the temporarily-calibrated model posture change unit 18 and the temporary posture difference acquisition unit 19 may be implemented by hardware for exclusive use, and another part of the functions may be implemented by software or firmware. For example, the function of the face image acquisition unit 11 can be implemented by the processing circuit 901 as hardware for exclusive use, and the functions of the face feature point extraction unit 12, the three-dimensional model acquisition unit 13 or 13a, the model posture change unit 14 or 14a, the degree of match acquisition unit 15 or 15a, the calibration unit 16 or 16a, the posture difference determination unit 17, the temporarily-calibrated model posture change unit 18 and the temporary posture difference acquisition unit 19 can be implemented by the processing circuit 901's reading and execution of a program stored in the memory 906.

Further, each of the head posture estimation devices 1 and 1a includes an input interface device 903 and an output interface device 904 that perform cable communication or wireless communication with devices like the image capture device 2.

Further, a combination of the above-mentioned embodiments can be freely made, changes can be made in any component according to any one of the above-mentioned embodiments, or any component according to any one of the above-mentioned embodiments can be omitted within the scope of the present disclosure.

### INDUSTRIAL APPLICABILITY

The head posture estimation device according to the present disclosure can be applied to a head posture estimation device that estimates the position and posture of a person's head.

### REFERENCE SIGNS LIST

1, 1a head posture estimation device, 2 image capture device, 11 face image acquisition unit, 12 face feature point extraction unit, 13, 13a three-dimensional model acquisition unit, 14, 14a model posture change unit, 141 selected model posture change unit, 15, 15a degree of match acquisition unit, 151 degree of selected point match acquisition unit, 16, 16a calibration unit, 161 first temporary calibration unit, 162 second temporary calibration unit, 17 posture difference determination unit, 18 temporarily-calibrated model posture change unit, 181 first temporary model posture change unit, 182 second temporary model posture change unit, 19 temporary posture difference acquisition unit, 901 processing circuit, 902 HDD, 903 input interface device, 904 output interface device, 905 CPU, and 906 memory.

1. A head posture estimation device comprising:
processing circuitry
to acquire a face image of an estimation target;
to extract multiple face feature points from the face image acquired;
to make a comparison on the face image between the multiple face feature points extracted and multiple model feature points on a first three-dimensional model showing a person's face which correspond to the respective multiple face feature points, and to change a position and posture of the first three-dimensional model in a virtual three-dimensional space in such a way that errors between positions of the multiple face feature points and positions of the multiple model feature points on the face image become less than or equal to respective thresholds for error determination;
to acquire degrees of match on the face image between the positions of the multiple model feature points on the first three-dimensional model having the position and posture of the first three-dimensional model which have been changed, and the positions of the multiple face feature points; and
to calibrate the first three-dimensional model by shifting a position of at least one model feature point out of the multiple model feature points in the first three-dimensional model on a basis of a corresponding one of the degrees of match acquired.

2. The head posture estimation device according to claim 1, wherein the processing circuitry selects, on a basis of the degrees of match acquired, a model feature point whose position is to be shifted to calibrate the first three-dimensional model, out of the multiple model feature points.

3. The head posture estimation device according to claim 1, wherein
the processing circuitry makes a comparison on the face image between some face feature points selected out of the multiple face feature points and selected model feature points on a second three-dimensional model showing a person's face which correspond to the respective selected face feature points, and changes a position and posture of the second three-dimensional model in the virtual three-dimensional space in such a way that errors between positions of the selected face feature points and positions of the selected model feature points on the face image become less than or equal to the respective thresholds for error determination,
the processing circuitry acquires degrees of selected point match on the face image between the positions of the selected model feature points on the second three-dimensional model having the position and posture of the second three-dimensional model which have been changed, and the positions of the selected face feature points,
the processing circuitry makes a first temporary calibration to the first three-dimensional model by shifting the at least one model feature point on a basis of the corresponding one of the degrees of match acquired,
the processing circuitry makes a second temporary calibration to the second three-dimensional model by shifting at least one of the selected model feature points on a basis of a corresponding one of the degrees of selected point match acquired,
the processing circuitry makes a comparison on the face image between the multiple face feature points and multiple model feature points on a first temporarily-calibrated three-dimensional model to which the first temporary calibration has been made, and changes a position and posture of the first temporarily-calibrated three-dimensional model in the virtual three-dimensional space in such a way that errors between the positions of the multiple face feature points and positions of the multiple model feature points on the face image become less than or equal to the respective thresholds for error determination,
the processing circuitry makes a comparison on the face image between the selected face feature points and selected model feature points on a second temporarily-calibrated three-dimensional model to which the second temporary calibration has been made, and changes a position and posture of the second temporarily-calibrated three-dimensional model in the virtual three-dimensional space in such a way that errors between the positions of the selected face feature points and positions of the selected model feature points on the face image become less than or equal to the respective thresholds for error determination,
the processing acquires a difference between the position and posture of the first temporarily-calibrated three-dimensional model which have been changed, and the position and posture of the second temporarily-calibrated three-dimensional model which have been changed, and
when the difference acquired is smaller than a threshold for difference determination, the processing circuitry calibrates the first three-dimensional model on a basis of the corresponding one of the degrees of match acquired, and also calibrates the second three-dimensional model by shifting a position of the at least one of the multiple selected model feature points in the second three-dimensional model on a basis of the corresponding one of the degrees of selected point match acquired.

4. A head posture estimation method comprising:
acquiring a face image of an estimation target;
extracting multiple face feature points from the face image acquired;
making a comparison on the face image between the multiple face feature points extracted and multiple model feature points on a first three-dimensional model showing a person's face which correspond to the respective multiple face feature points, and changing a position and posture of the first three-dimensional model in a virtual three-dimensional space in such a way that errors between positions of the multiple face feature points and positions of the multiple model feature points on the face image become less than or equal to respective thresholds for error determination;
acquiring degrees of match on the face image between the positions of the multiple model feature points on the first three-dimensional model having the position and posture of the first three-dimensional model which have been changed, and the positions of the multiple face feature points; and
calibrating the first three-dimensional model by shifting a position of at least one model feature point out of the multiple model feature points in the first three-dimensional model on a basis of a corresponding one of the degrees of match acquired.
